(19) United States
(12) Patent Application Publication
(10) Pub. No.: US 2015/0260123 A1
(43) Pub. Date: Sep. 17, 2015

(54) Internal Combustion Engine Having a Cylinder Head Which is Configured Jointly for a Plurality of Cylinders

(71) Applicant: AVL LIST GMBH, Graz (AT)

(72) Inventor: Christof Knollmayr, Graz (AT)

(73) Assignee: AVL LIST GMBH, Graz (AT)

(21) Appl. No.: 14/430,067

(22) PCT Filed: Sep. 25, 2013
(86) PCT No.: PCT/EP2013/069890

§ 371 Date: Mar. 23, 2015

(30) Foreign Application Priority Data
Sep. 25, 2012 (AT) A 50409/2012

(51) Int. Cl. F02F 1/40; F02F 11/00; F01P 3/02; F02F 1/00

(52) U.S. Cl. CPC F02F 1/40; F02F 1/004; F02F 11/002; F02F 11/005; F01P 3/02

(57) ABSTRACT

The invention relates to an internal combustion engine (1) having a cylinder head (2) which is configured jointly for a plurality of cylinders (Z) and a liner unit (3) for a plurality of cylinders (Z) which is fastened to the cylinder head (2), wherein a cooling jacket arrangement having at least one cooling jacket (6, 7) is formed into the liner unit (3), which cooling jacket arrangement preferably surrounds the cylinders (Z). In order to avoid deformations of the liner unit (3), it is provided that the liner unit (3) has a clearance with respect to a surrounding cylinder housing (9).

The invention relates to an internal combustion engine having a cylinder head which is configured jointly for a plurality of cylinders and a liner unit for a plurality of cylinders which is fastened to the cylinder head, wherein a cooling jacket arrangement having at least one cooling jacket is formed into the liner unit, which cooling jacket arrangement preferably surrounds the cylinders.

FR 551 128 discloses an internal combustion engine with a liner unit fixed to the cylinder head, wherein a cooling jacket is arranged between the liner unit and a surrounding housing.

DE 198 49 912 describes a liquid-cooled internal combustion engine with a crankcase in so-called open-deck configuration, in which a plate is arranged between said crankcase and the cylinder head, which plate is connected to or integrally arranged with the cylinder liners, and which is screwed together to a unit with the cylinder head by interposing the cylinder head gasket. This unit is connected to the crankcase by cylinder head screws. The plate comprises a cooling liquid chamber, which is in connection on the one hand by openings in the base of the plate to a cooling liquid chamber in the crankcase surrounding the liners and on the other hand by openings in the cylinder head gasket to a liquid chamber in the cylinder head.

Furthermore, an internal combustion engine with a cylinder head and a divided cylinder block is also known from EP 1 706 624, wherein the divided cylinder block comprises an inner block part with a liner unit and an outer block part forming an outer housing.

GB 2 485 542 A discloses an assembled cylinder block with a uniform inner core, which comprises one or several cylinder bores and a main bearing for a crankshaft, wherein the inner core is encased by a uniform upper crankcase. The inner core is inserted into the upper outer crankcase and is rigidly connected thereto.

JP 10-169 503 A discloses an internal combustion engine with a cylinder head and a liner unit, wherein the liner unit comprises a flange which is arranged between the crankcase and the cylinder head, wherein the crankcase and the cylinder head are connected to each other by screwed connections.

A crankcase is known from JP 62-113 846 A, which crankcase comprises a co-cast liner unit, wherein a cooling jacket is formed into the liner unit.

A crankcase with inserted liners with an integrated water cooling jacket is further known from JP 05-078 950 U, wherein the liner plus water cooling jacket are pressed into the cylinder of the cylinder block of the crankcase.

Known internal combustion engines with a liner unit come with the disadvantage that deformations of the liner unit may occur as a result of tensions between the liner unit and the cylinder housing.

It is the object of the invention to prevent deformations of the liner unit.

This is achieved in accordance with the invention such a way that the liner unit has a clearance with respect to a surrounding cylinder housing.

The liner unit preferably also has a clearance with respect to the crankshaft bearings of the crankshaft.

It is especially advantageous if the liner unit also has a clearance with respect to the cylinder head screws connecting the cylinder head to the cylinder housing.

Tensions between the liners and the cylinder housing are prevented and the deformations of the liners are reduced in such a way that the liner unit is entirely clear with respect to tensions and vibrations against the cylinder housing, the crankshaft bearings and/or the cylinder head screws.

Provided with clearance shall mean in this case that there is no direct corporeal connection between the liner unit and the cylinder housing, the cylinder head screws and or the crankshaft bearings, so that power flows and structure-borne sound transmissions can only occur via a third part, namely the cylinder head.

The liner unit can releasably be connected to the cylinder head in the area of a fastening region adjacent to the cylinder head by at least one screwed connection, preferably via tabs integrally attached to a circumferential region of the liner unit, wherein preferably the liner unit is fixed by means of screws to the cylinder head, preferably from the side of the cylinder housing. The power flow of the cylinder head screws thus no longer extends through the cylinder liners to the crankshaft. This leads to the advantage that the deformations of the liners can be reduced.

It can also be provided as an alternative or in addition to screws that the liner unit is fixed by means of a glued connection to the cylinder head.

It can be provided in a further embodiment of the invention that the liner unit is sealed towards the cylinder head by means of a liquid seal.

The cooling jacket no longer needs to be sealed against the cylinder housing due to the fact that the liner unit is formed into the cooling jacket. This facilitates production and mounting work.

A first cooling jacket arranged in a region of the liner unit facing the cylinder head can be flow-connected to a cooling water flow path, preferably at least one cooling-water feed and/or discharge conduit in the cylinder head. The feed and discharge of the coolant thus only occurs via the cylinder head. The cylinder housing can be arranged to be fully free from cooling water conduits and cooling water feed and discharge conduits. This substantially simplifies the production of the cylinder housing.

In order to enable simple production, it is advantageous if the first cooling jacket is arranged in an open manner towards the cylinder head, preferably in open-deck configuration. This allows simple production of the first cooling jacket of the liner unit. The supply of the cooling jacket water thus only occurs via the cylinder head. Separate feed and discharge openings in the cylinder block are thus no longer required.

In order to enable especially good tempering of the cylinders, it is advantageous if a second cooling jacket is arranged in a region of the liner unit which faces away from the cylinder head, which second cooling jacket is preferably separate from the first cooling jacket and is connected to a motor oil flow path. As seen with respect to the cylinder axes, the first and the second cooling jacket are arranged in different axial sections of the liner unit.

The first and the second cooling jackets comprise each cylinder and are respectively arranged in a continuous manner for all cylinders.

The regions of the cylinder liners which are assumed by the pistons in the cylinders in the region of the upper dead centres are cooled by the first cooling jacket on the one hand, and the regions of the cylinder liners associated with the bottom dead centres of the pistons are cooled by the second cooling jacket on the other hand. This allows different tempering of the upper and bottom regions of the cylinders.

The invention will be explained below in closer detail by reference to the drawings wherein:

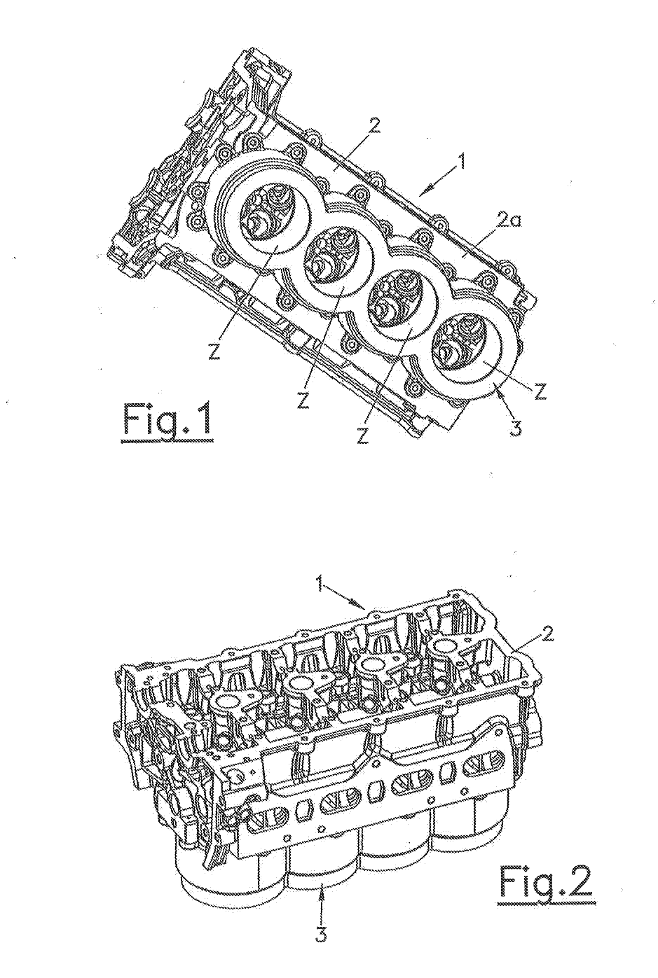

FIG. 1 shows a cylinder head plus liner unit of an internal combustion engine in accordance with the invention in an oblique view from below;

FIG. 2 shows the cylinder head plus liner unit in an oblique view from above;

FIG. 3 shows the cylinder head in a side view;

FIG. 4 shows the internal combustion engine in a top view;

FIG. 5 shows the internal combustion engine without cylinder housing in a sectional view along the line V-V in FIG. 4;

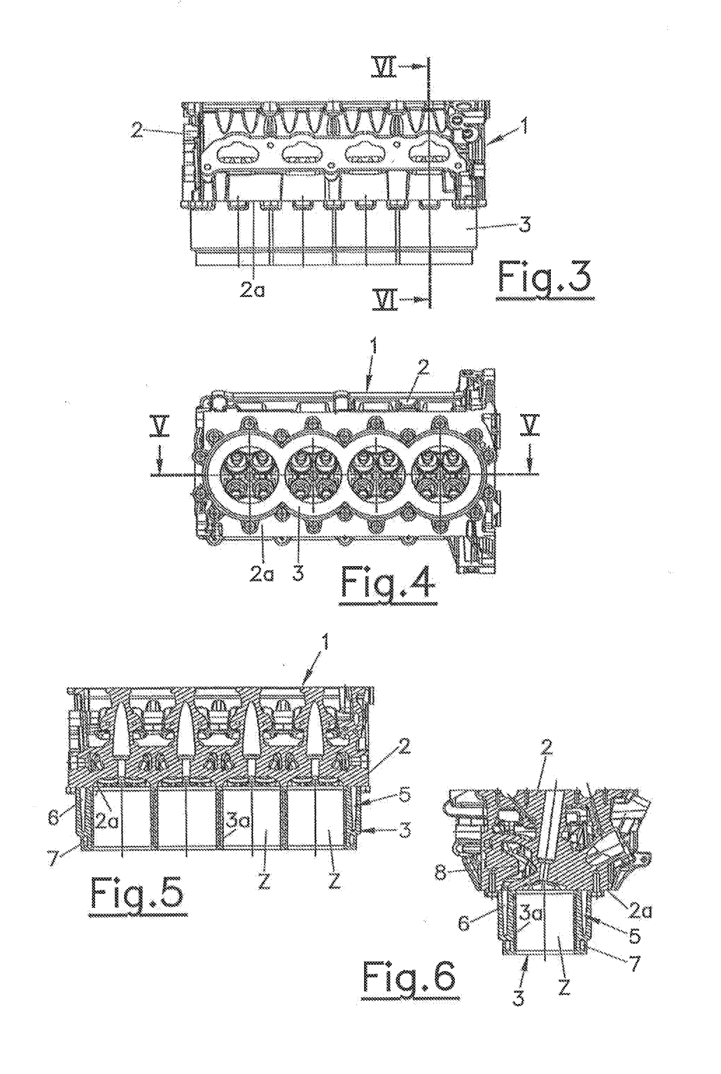

FIG. 6 shows the internal combustion engine without cylinder housing in a sectional view along the line VI-VI in FIG. 3;

FIG. 7 shows a liner unit in an oblique view from below;

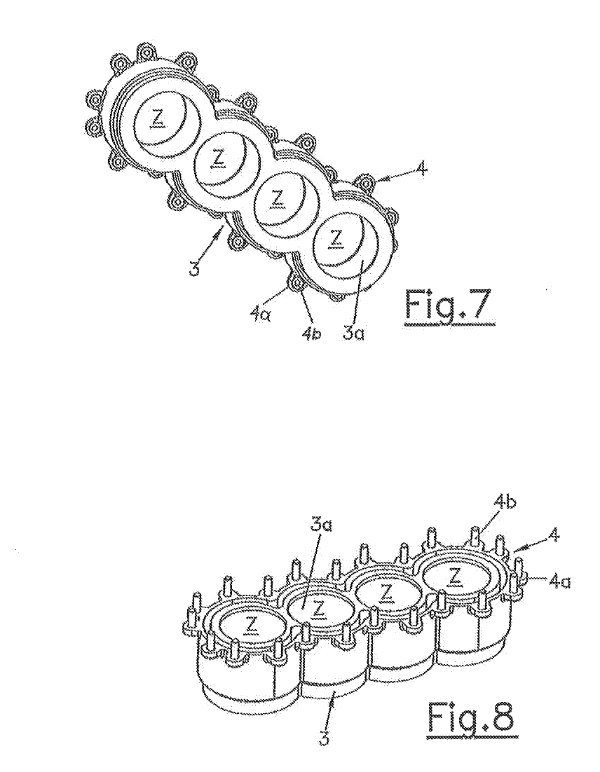

FIG. 8 shows the liner unit in an oblique view from above;

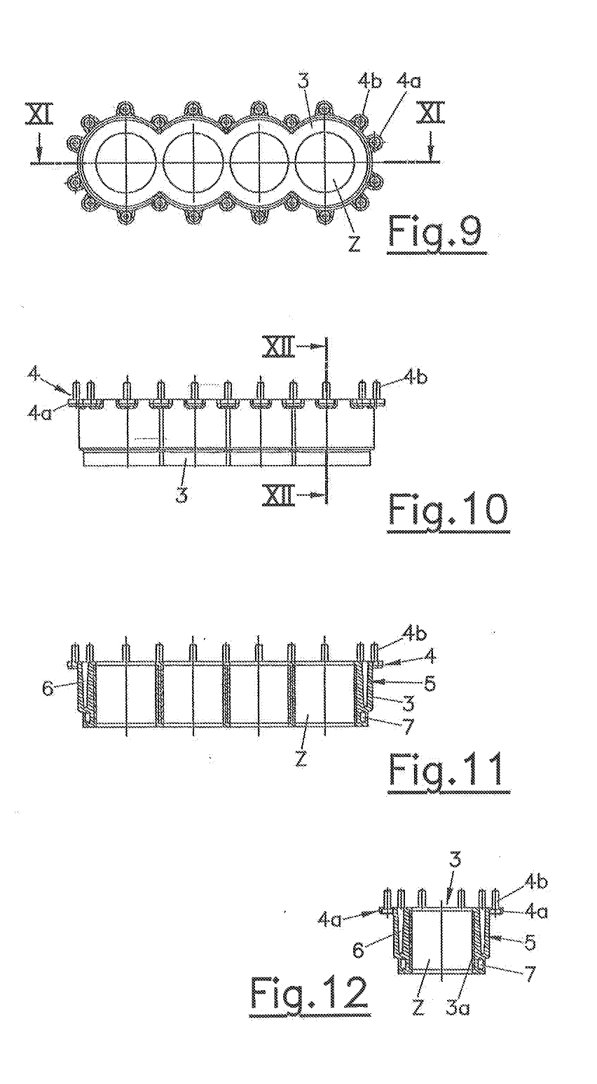

FIG. 9 shows the liner unit in a top view;

FIG. 10 shows the liner unit in a side view;

FIG. 11 shows the liner unit in a sectional view along the line XI-XI in FIG. 9;

FIG. 12 shows the liner unit in a sectional view along the line XII-XII in FIG. 10, and

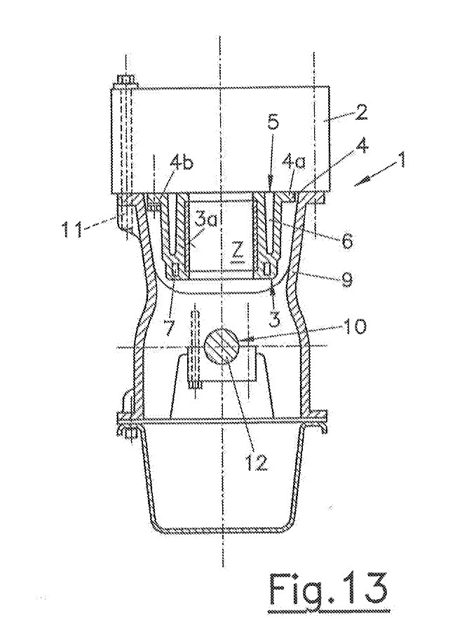

FIG. 13 shows the internal combustion engine plus the cylinder housing in a further sectional view along the line VI-VI in FIG. 3.

The drawings show an internal combustion engine 1 with a cylinder head 2, wherein a liner unit 3 for several cylinders Z is fixed to the cylinder head 2. The liner unit 3 for several cylinders Z is integrally arranged and in the embodiment comprises tabs 4a for accommodating fastening screws 4b which are integrally attached to the outer circumference in a fastening region 4 which is adjacent to the fire deck 2a of the cylinder head 2. The liner unit 3 is fixed from the side of the cylinder housing 9 to the cylinder head 2 by a screwed connection 4b formed by the fastening screws. Simple and rapid mounting and dismounting of the liner unit 3 on the cylinder head 2 is enabled by means of said screwed connection 4b. The liner unit 3 can also be connected by a glued connection to the cylinder head 2 as an alternative or in addition to the screwed connection 4b.

FIGS. 1 to 12 show the internal combustion engine 1 without the cylinder housing. FIG. 13 on the other hand shows the internal combustion engine 1 with the cylinder housing 9.

The fastening region 4 is situated in a region adjacent to the cylinder head 2. The liner unit 3 is thus fastened by said fastening region 4 to the cylinder head 2. The liner unit 3 is surrounded in the mounted state by a cylinder housing 9 which is shown in FIG. 13 and connected to the cylinder head 2, and is provided with clearance against said cylinder housing and against the crankshaft bearings 10 and the cylinder head screws 11. The power flow of the cylinder head screws 11 thus no longer extends through the cylinder liner unit 3 to the crankshaft 12, but only via the cylinder housing 9. This leads to the advantage that the deformations of the liner unit 3 can be reduced because the fastening and supporting forces do not extend through the entire axial extension of the liners. The liner unit 3 is thus fastened in a “suspended” manner only to the cylinder head.

The liner unit 3 comprises a cooling jacket arrangement 5 with a first cooling jacket 6 adjacent to the cylinder head 2 and a second cooling jacket 7, wherein the second cooling jacket 7 is arranged in a bottom region of the liner unit 3 which faces away from the cylinder head 2.

The first and the second cooling jacket 6, 7 surround all cylinders Z. The first cooling jacket 6 is arranged in an open manner towards the cylinder head 2 and is in flow-connection with a coolant feed conduit 8 and/or a coolant discharge conduit (not shown) in the cylinder head 2. Production of the liner unit 3 is facilitated because the first cooling jacket 6 is arranged with an upwardly open configuration. The second cooling jacket 7 is in connection with the flow paths which conduct the motor oil.

The liner unit 3 can be provided in the region of the cylinder Z with a separate bearing surface 3a, which bearing surface 3a can be formed by a coating or a cast-in sleeve.

1. An internal combustion engine, comprising a cylinder head which is configured jointly for a plurality of cylinders and a liner unit for a plurality of cylinders which is fastened to the cylinder head, wherein a cooling jacket arrangement having at least one cooling jacket is formed into the liner unit, wherein the liner unit has a clearance with respect to a surrounding cylinder housing.

2. The internal combustion engine according to claim 1, wherein the liner unit has a clearance with respect to the crankshaft bearings of the crankshaft

3. The internal combustion engine according to claim 1, wherein the liner unit has a clearance with respect to the cylinder head screws which connect the cylinder head to the cylinder housing.

4. The internal combustion engine according to claim 1, wherein the liner unit is fastened to the cylinder head in a fastening region adjacent to the cylinder head.

5. The internal combustion engine according to claim 1, wherein the liner unit is fastened to the cylinder head by means of at least one screwed connection.

6. The internal combustion engine according to claim 1, wherein the liner unit is fastened by means of at least one glued connection to the cylinder head.

7. The internal combustion engine according to claim 1, wherein the liner unit is sealed by means of a liquid seal towards the cylinder head.

8. The internal combustion engine according to claim 1, wherein a first cooling jacket is arranged in a region of the liner unit adjacent to the cylinder head.

9. The internal combustion engine according to claim 8, wherein the first cooling jacket is flow-connected to a cooling water flow path.

10. The internal combustion engine according to claim 8, wherein the first cooling jacket is arranged with an open configuration towards the cylinder head.

11. The internal combustion engine according to claim 8, wherein a second cooling jacket is arranged in a region of the liner unit facing away from the cylinder head.

12. The internal combustion engine according to claim 11, wherein the second cooling jacket is connected to a motor oil flow path.

13. The internal combustion engine according to claim 1, wherein the cooling jacket arrangement surrounds the cylinders.

14. The internal combustion engine according to claim 4, wherein the liner unit is fastened to the cylinder head by means of tabs.

15. The internal combustion engine according to claim 5, wherein the liner unit is fastened from the side of the cylinder housing.

16. The internal combustion engine according to claim 9, wherein the first cooling jacket is flow-connected to at least one cooling water feed and/or discharge conduit in the cylinder head.

17. The internal combustion engine according to claim 8, wherein the first cooling jacket is arranged with an open configuration towards the cylinder head in open-deck configuration.

18. The internal combustion engine according to claim 11, wherein the second cooling jacket is separated from the first cooling jacket.
